(19) United States
(12) Patent Application Publication
(10) Pub. No.: US 2014/0205781 A1
(43) Pub. Date: Jul. 24, 2014

(54) SILICONE ESPUN PTFE COMPOSITES

(71) Applicant: ZEUS INDUSTRIAL PRODUCTS, INC., Orangeburg, SC (US)

(72) Inventors: Robert L. Ballard, Orangeburg, SC (US); Bruce L. Anneaux, Lexington, SC (US); Joshua Manasco, Columbia, SC (US); Ping Hao, Waxhaw, NC (US); Jeffrey D. Moulton, Columbia, SC (US)

(73) Assignee: Zeus Industrial Products, Inc., Orangeburg, SC (US)

(21) Appl. No.: 13/827,886

(22) Filed: Mar. 14, 2013

Related U.S. Application Data
(60) Provisional application No. 61/755,833, filed on Jan. 23, 2013.

(51) Int. Cl. C08J 9/42

(52) U.S. Cl. CPC C08J 9/42
USPC 428/36.5; 428/308.4; 428/195.1; 427/387; 427/177; 156/189

(57) ABSTRACT

The present disclosure provides a composite material comprising a silicone component and an electrospun, porous polymeric component and methods of producing such a composite material. The layers are preferably processed so as to result in some degree of penetration of the silicone component into the pores of the electrospun polymeric component. The composite materials can be tailored for use in a range of different applications.

### CROSS-REFERENCE TO RELATED APPLICATION

This application claims the benefit of U.S. Provisional Application No. 61,755,833, filed Jan. 23, 2013.

### INCORPORATION BY REFERENCE

The entire disclosure of U.S. Provisional Application No. 61,755,833, filed Jan. 23, 2013, is incorporated herein by reference.

### FIELD OF THE INVENTION

The invention is generally related to composite materials, products comprising such composite materials, and to methods of making and using such composite materials and products.

### BACKGROUND

Silicone-based materials are widely used in a range of disciplines, such as in medical applications, electrical applications, automotive applications, and chemical applications.

Silicones are regarded for their stability, water resistance, heat resistance, chemical resistance, and physiological inertness.

Silicones (also known as polysiloxanes) are polymers comprising silicon in combination with carbon, hydrogen, and oxygen. Structurally, silicones comprise a silicon and oxygen backbone (Si—O—Si) with organic pendant groups attached thereto. The organic pendant groups can be varied, leading to materials with widely varying physical properties. For example, silicones can range from solid (e.g., rigid or rubbery) to semi-solid (e.g., gel-like or paste-like) to liquid in texture. Three representative classes of silicones include silicone oils, silicone resins, and silicone elastomers.

Silicones are commonly used as components of such materials as sealants (e.g., silicone caulk, silicone gaskets, etc.), adhesives, lubricants (silicone oils and greases), dry-cleaning solutions, cookware (e.g., in parchment paper, spatulas/spoons, and non-stick sprays), apparel, insulation (e.g., electrical enclosures), personal hygiene (e.g., shampoo and shaving gels), and medical applications (e.g., implants, bandages, catheters, vascular/dialysis/chemotherapy ports, tracheal/feeding tubes, and contact lenses).

Typically, although silicones exhibit many desirable physical properties (as described above), silicone-based materials often suffer from poor tear strength and toughness, which is a disadvantage in certain applications. Consequently, silicones are often reinforced with other types of materials to enhance these deficiencies. Certain exemplary reinforced silicones include the types of materials described in U.S. Pat. No. 2,710,290 to Safford et al.; U.S. Pat. No. 2,927,908 to Konkle; U.S. Pat. No. 4,640,951 to Skostins; U.S. Pat. No. 6,673,455 to Zumbrum et al.; U.S. Pat. No. 7,799,842 to Anderson et al.; U.S. Pat. No. 8,088,449 to Bailey et al.; and U.S. Pat. No. 8,273,448 to Zhu, which are all incorporated herein by reference in their entireties.

It would be beneficial to provide additional silicone-containing materials that exhibit enhanced physical and mechanical properties as compared to silicone alone.

### SUMMARY

In accordance with certain embodiments of the present disclosure, a composite material comprising an electrospun polymeric material in combination with a silicone material is provided. In some embodiments, the structure of the composite material is substantially uniform. For example, in certain embodiments, the silicone material penetrates a substantial portion of the pores present in the electrospun polymeric material, resulting in a three-dimensional electrospun polymeric material network with silicone material penetrating throughout (i.e., an interpenetrating network). More generally described and in accordance with certain embodiments, the silicone may be characterized as being fully impregnated in the electrospun polymeric material. Although the composite materials described herein are typically prepared in layers (i.e., at least one layer of electrospun polymeric material in combination with at least one layer (e.g., coating) of silicone material), the final composite in certain embodiments exhibits little layering. In some embodiments, the final composite exhibits a high degree of penetration of silicone material into the electrospun polymeric material, such that the original layers are substantially not visible in the final composite. In other embodiments, distinct layers are formed, wherein only a portion of the silicone may be at least partially impregnated in the electrospun polymeric material.

In certain embodiments, the electrospun polymeric material in the composite materials comprises electrospun poly(tetrafluoroethylene) (espun PTFE). The ratio of silicone material to electrospun polymeric material can vary in the composites described herein. In certain embodiments, the amount of silicone material is that amount needed to substantially fill the pores of the electrospun polymeric material. The present disclosure also provides a method for the production of a composite material comprising an electrospun polymeric material in combination with a silicone material. Further, the disclosure provides various products (e.g., tubes and membranes) comprising the composite materials described herein.

The specific method by which the composite materials and products comprising such composite materials of the present disclosure can be prepared can vary depending, in part, on the makeup of the various components of the composite material. The method can be adapted, based on the principles described herein, to provide a range of composite materials having different physical properties that are tailored for specific purposes.

In one aspect, the present disclosure provides a composite material comprising an electrospun polymeric component, having pores therein, and an elastomer, wherein at least a portion of the elastomer penetrates at least a portion of the pores of the electrospun polymeric component. In another aspect, the present disclosure provides a composite material comprising an electrospun polymeric component, having pores therein, and silicone, wherein at least a portion of the silicone penetrates at least a portion of the pores of the electrospun polymeric component. In certain embodiments, the electrospun polymer comprises poly(tetrafluoroethylene) (PTFE).

The composite materials described herein can be processed into various forms. For example, in some embodiments, tubes, gaskets, pump diaphragms, bellows, and o-rings comprising the composite materials described herein are provided. As a specific example, in certain embodiments, peristaltic pump tubing comprising a composite material is provided according to the present disclosure. Tubes can be provided that exhibit different cross-sectional properties. In some embodiments, the tube wall exhibits a substantially homogeneous cross-section. In other embodiments, the tubing comprises a wall with a cross-section that exhibits alternating layers of silicone and silicone-penetrated electrospun polymeric material. Various combinations of the homogenous and layered features are within the scope of this disclosure.

Another aspect of the present disclosure is the provision of a method for producing a composite material. In one example, the method may comprise applying uncured silicone to a porous electrospun polymer mat; and applying pressure to cause at least a portion of the silicone to penetrate at least a portion of the pores of the electrospun polymer mat. In some embodiments, the method further comprises partially curing (e.g., prior to the step of applying pressure) and/or fully curing the silicone (e.g., after the step of applying pressure). Various additional processing steps can be conducted on the composite materials thus produced, including but not limited to, compression molding, injection molding, blow molding, extrusion, and lamination.

The foregoing presents a simplified summary of some aspects of this disclosure in order to provide a basic understanding. The foregoing summary is not extensive and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

A full and enabling disclosure, directed to one of ordinary skill in the art, is set forth more particularly in the remainder of the specification, which makes reference to the following figures.

FIG. 1 is a scanning electron micrograph (SEM) image showing a cross-sectional view of the textured inner diameter surface of a tube comprising a composite silicone/PTFE material as described herein, in accordance with an embodiment of this disclosure, wherein the cross section is perpendicular to the length of the tube.

FIG. 2 is a schematic cross-sectional image of a larger portion of the tube of FIG. 1, highlighting (with a square) the approximate location within the tubing cross-section represented by the image of FIG. 1.

FIG. 3 is an SEM image showing a cross-sectional view of the interior of the wall of the tube of FIG. 1, wherein the cross section is perpendicular to the length of the tube.

FIG. 4 is a schematic cross-sectional image of a larger portion of the tube of FIG. 1, highlighting (with a square) the approximate location within the tubing cross-section represented by the image of FIG. 3.

FIG. 5 is an SEM image showing a cross-sectional view of the outer diameter surface of the tube of FIG. 1, wherein the cross section is perpendicular to the length of the tube.

FIG. 6 is a schematic cross-sectional image of a larger portion of the tube of FIG. 1, highlighting (with a square) the approximate location within the tubing cross-section represented by the image of FIG. 5.

FIG. 7 is an SEM image that is similar to the image of FIG. 1, showing a cross-sectional view of the textured inner diameter surface of another tube comprising a composite silicone/PTFE material as described herein.

FIG. 8 is an SEM image that is similar to the image of FIG. 1, showing a cross-sectional view of the textured inner diameter surface of another tube comprising a composite silicone/PTFE material as described herein.

FIG. 9 schematically illustrates a portion of a silicone-coated electrospun polymeric fabric being wrapped around (e.g., wound onto) a mandrel with a textured exterior surface, in accordance with an example of a method of making the tubes of FIGS. 1-7.

FIG. 10 is a schematic cross-sectional image of a homogeneous composite tube comprising composite silicone/PTFE material as described herein, in accordance with another embodiment of this disclosure, wherein the cross section is perpendicular to the length of the tube.

FIG. 11 is a schematic cross-sectional image of a gradient composite tube comprising composite silicone/PTFE material as described herein, in accordance with another embodiment of this disclosure, wherein the cross section is perpendicular to the length of the tube.

FIG. 12 is a schematic cross-sectional image of a tube that has distinct layers and comprises composite silicone/PTFE material as described herein, in accordance with another embodiment of this disclosure, wherein the cross section is perpendicular to the length of the tube.

### DETAILED DESCRIPTION

The present invention will now be described more fully hereinafter with reference to the accompanying figures, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Each example is provided by way of explanation of the disclosure, and is not intended to be limiting of the disclosure. In fact, it will be apparent to those skilled in the art that various modifications and variations can be made in the present disclosure without departing from the scope or spirit of the invention. For instance, features illustrated or described as part of one embodiment can be used in the context of another embodiment to yield a further embodiment. Thus, it is intended that the present disclosure covers such modifications and variations as come within the scope of the disclosed embodiments and their equivalents.

Generally, the present disclosure provides composite materials comprising a silicone material and an electrospun (also referred to herein as “espun”) polymeric material and methods of preparation thereof. The composite materials of the present disclosure can, in certain embodiments, offer a number of advantages over conventional silicone-containing materials and products produced therefrom.

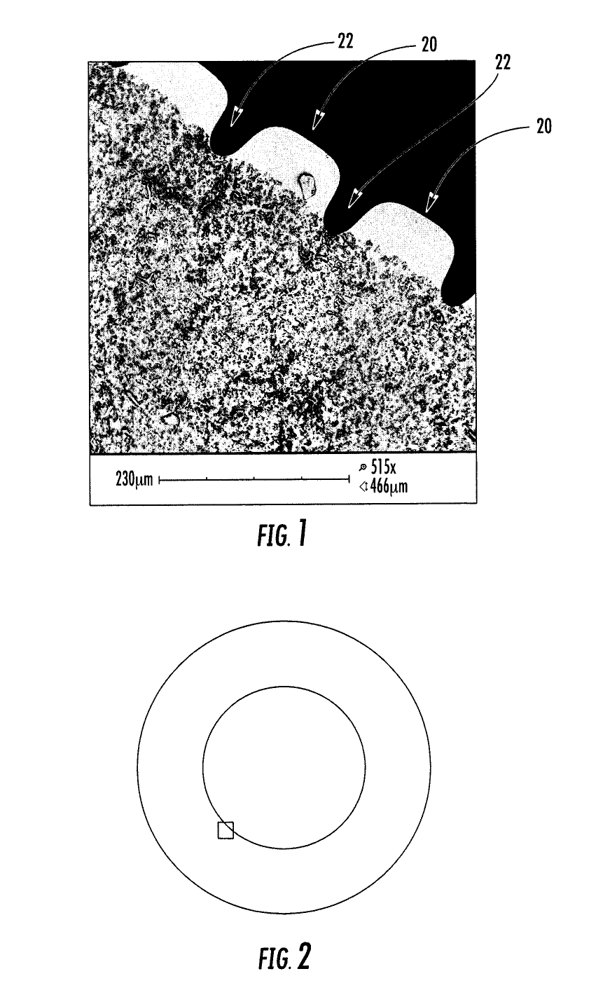

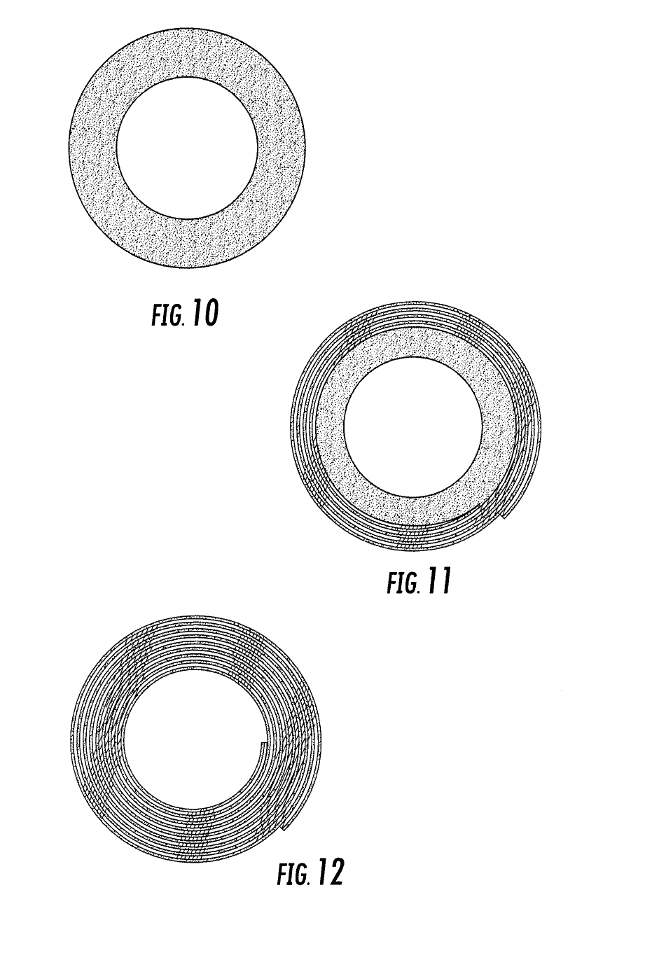

For example, in certain embodiments, the present disclosure advantageously provides one or more of: the ability to vary (including the ability to maximize) penetration of (e.g., impregnation of) the silicone material into the espun polymeric material, providing increased strength and decreased potential for delamination/separation of the two or more material types (i.e., the electrospun material and the silicone material); the ability to provide one or more material surfaces having varying structure/texture (which can, in some embodiments, provide increased surface area as compared to a smooth surface), as shown, for example, in FIGS. 1, 7 and 8; the ability to produce a material having a substantially uniform, homogeneous cross-section, as shown, for example, in FIGS. 3 and 10; the ability to produce a material having distinct layers as at least partially shown, for example, FIGS. 1, 5, 7, 8, 11 and 12; the ability to produce a material having a gradient structure as shown, for example, in at least FIG. 11; the ability to incorporate electrospun materials with vastly different pore structures and sizes (allowing for varying levels of permeability, adhesion, etc., and varying levels of penetration of the silicone material into the electrospun material(s)); the ability to incorporate multiple types of materials within the composite material; and/or the option to incorporate one or more additives within the composite material. Other advantages with regard to certain applications of the composite materials described herein are also afforded.

The ratio of the silicone component to the electrospun polymeric component can vary widely and can be tailored for use in a given application. In certain embodiments, the ratio is advantageously sufficient to ensure that the resulting composite is elastomeric to some degree. Typically, care must be taken to avoid too little of the silicone component (which can result in a plastic-like material, lacking significant resilience) and to avoid too little of the electrospun polymeric component (which can result in decreased flexural strength due to insufficient pore structure into which the silicone can penetrate). Preferably, in certain embodiments, the amount of silicone is that amount sufficient to substantially or completely penetrate an electrospun polymeric mat (from one surface to the other). Where a homogeneous structure is desired, it is advantageous to control the amount of silicone such that a large quantity of silicone does not pass through the electrospun polymeric material and accumulate as a layer on one or both surfaces of the electrospun polymeric material. Certain composite materials described herein comprise at least about as much silicone by weight as electrospun polymeric material; however, embodiments are also provided which comprise less silicone than electrospun polymeric material by weight. For example, in some embodiments, the silicone:electrospun polymeric material volume ratio is from about 1:15 to about 5:1.

The composite materials provided by the present disclosure can have varying compositions and can be tailored for specific purposes. Any combination of electrospun polymeric material(s) and silicone material(s) can be useful according to the materials and methods provided by the present disclosure.

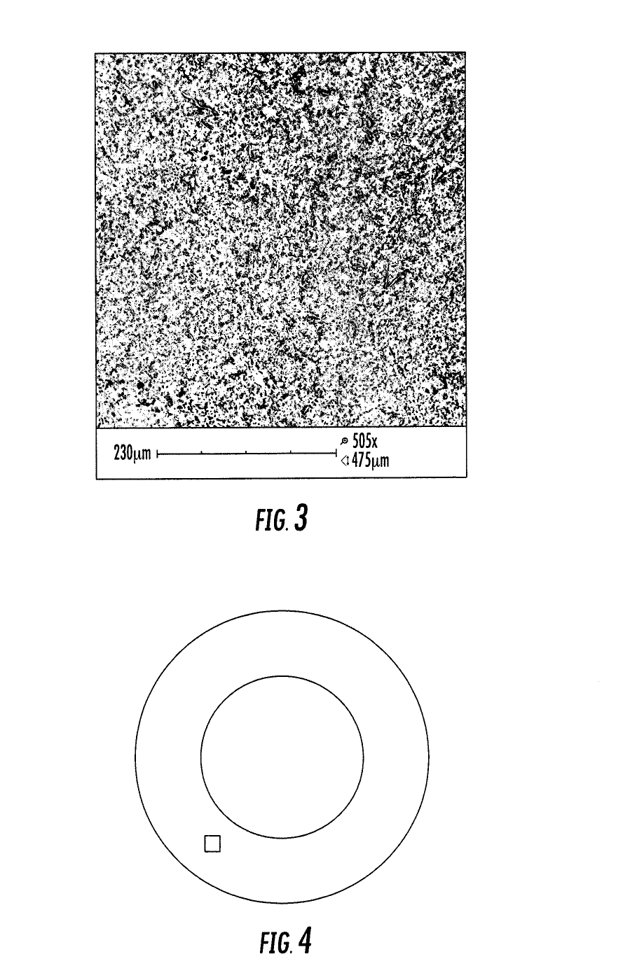

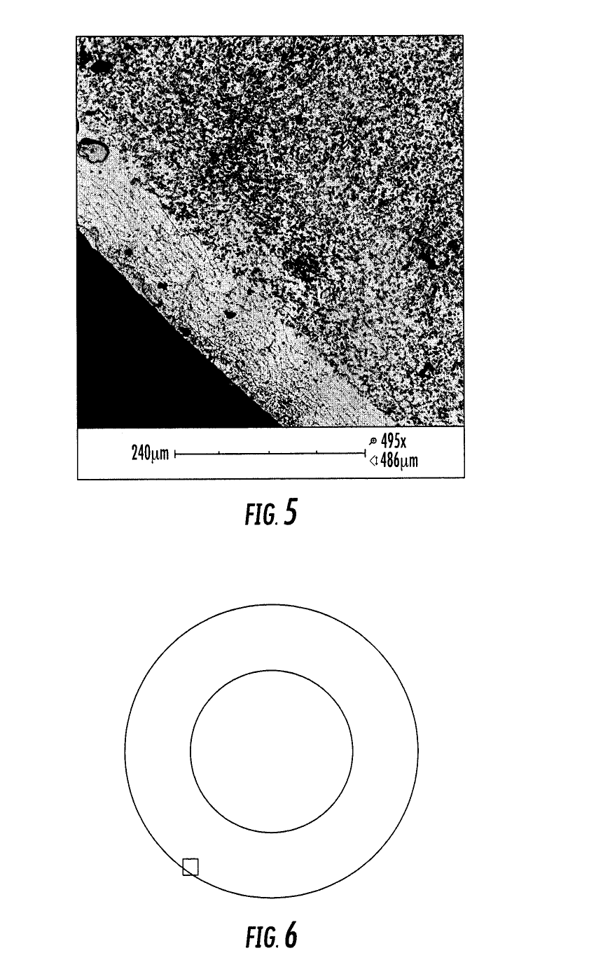

As will be discussed in greater detail below, composite materials of this disclosure may be configured in a variety of different forms. For example and not for the purpose of limiting the scope of this disclosure, the composite materials may be in the form of composite tubes, wherein the tubes comprise, consist essentially of, or consist of an espun polymeric component and a silicone compound. As a more specific example and in accordance with one embodiment of this disclosure, FIGS. 1-6 illustrate respective portions of a composite tube that may comprise, consisting essentially of, or consist of an espun nonwoven web (e.g., a poly(tetrafluoroethylene) (PTFE) espun nonwoven fabric) and a silicone compound, wherein at least some of the silicone compound is impregnated in the nonwoven fabric.

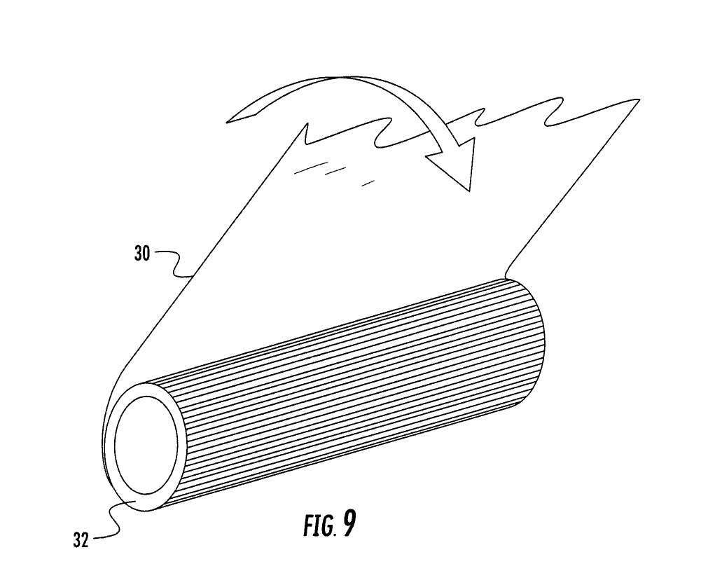

Referring to FIG. 1, the inner surface of the tube is textured. As will be discussed in greater detail below in association with FIG. 9, the textured pattern defined by the inner surface of the tube may be configured differently or may be omitted. Notwithstanding, in the embodiment shown in FIG. 1, inner surface of the tube is textured such that it includes elongate features that each extend along the length of the tube, wherein the features include an alternating series of elongate ridges or protrusions 20, and elongate recesses or grooves 22, and each of the protrusions and grooves extends along the length of the tube. The protrusions 20 may be characterized as being part of a distinct innermost layer of the tube, wherein in the direction around the longitudinal axis of the tube the inner layer is discontinuous as a result of the grooves 22.

The tube of FIGS. 1-6 may be characterized as having an outermost layer opposite the innermost layer, and a central layer positioned between the innermost and outermost layers. As an example of the distinctness between the protrusions 20/innermost layer of the tube and the adjacent central layer of the tube, in FIGS. 1, 3 and 5, the cross sectioned portions of the PTFE espun nonwoven fabric generally have the appearance of dark stippling, whereas the cross-sectioned portions of the silicone compound generally have a white appearance. Accordingly, in the embodiment shown in FIG. 1, the protrusions 20/innermost layer of the tube consist primarily of, or essentially of, the silicone compound, whereas the central layer of the tube consist primarily of, or essentially of, a homogeneous composite material comprising both the silicone compound and the PTFE espun nonwoven fabric. FIG. 3 further illustrates the homogeneous composite material of the central layer of the tube. That is, FIG. 3 illustrates a substantially homogeneous cross-section of a portion of the subject tube.

FIG. 5 illustrates an example of the distinctness between the outermost layer of the tube and the adjacent central layer of the tube. Again, the cross sectioned portions of the PTFE espun nonwoven fabric generally have the appearance of dark stippling, where as the cross-sectioned portions of the silicone compound generally have a white appearance. Accordingly, FIG. 5 at least generally illustrates that the outermost layer of the tube consist primarily of or essentially of, the silicone compound, which is in contrast to the homogeneous composite material of the central layer of the tube. The outermost layer shown in FIG. 5 may be in the form of, or may be referred to as, a silicone flap.

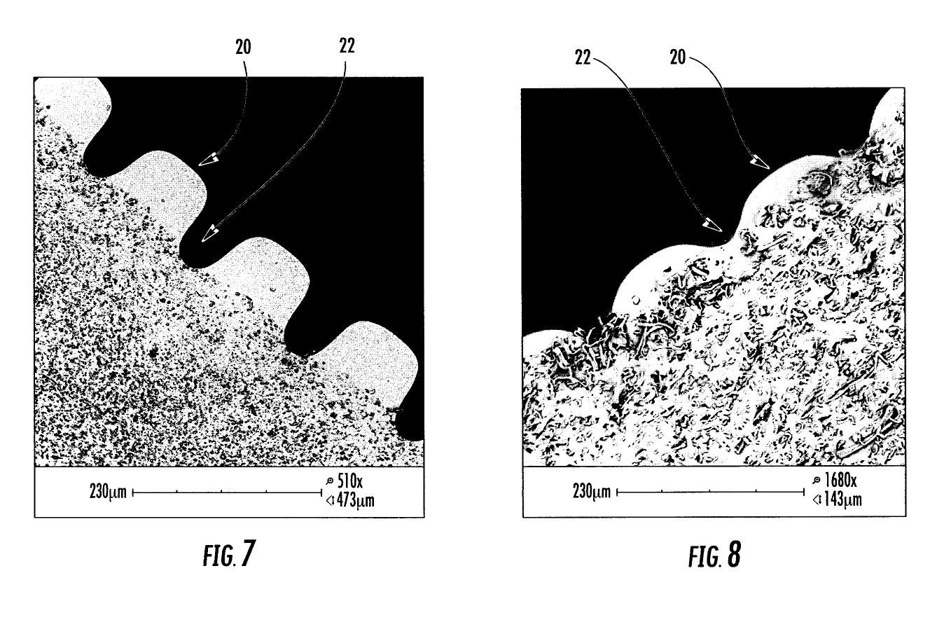

As will be discussed in greater detail below, the tubes and other constructs of this disclosure may have other types of differently configured layers. For example, FIGS. 7 and 8 illustrate other tubes that may be like the tube of FIGS. 1-6, except for variations noted and variations that will be apparent to those of ordinary skill in the art. For example, the inner layers/protrusions 20/grooves 22 of FIGS. 7 and 8 are in some ways similar to the inner layer/protrusions 20/grooves 22 of FIG. 1. On the other hand, the inner layers/protrusions 20/grooves 22 of FIGS. 7 and 8 are in at least some ways different from the inner layer/protrusions 20/grooves 22 of FIG. 1, such as with regard to shape, size and/or other variations.

In the following, a more detailed discussion of exemplary aspects of silicone components of constructs of this disclosure is followed by a more detailed discussion of exemplary aspects of nonwoven (e.g., electrospun polymeric) components of constructs of this disclosure. Thereafter, exemplary aspects associated with preparing composite materials and using the composite materials are discussed, followed by a discussion of additional examples.

### Silicone Component

The silicone component of the composite materials can be any suitable type of silicone polymer or copolymer. Although the present disclosure is directed principally to silicone materials in combination with electrospun materials, it is noted that the silicone can, in some embodiments, be replaced with other types of elastomers (e.g., including but not limited to, urethanes, nitrile rubber, styrene-butadiene-styrene (SBS), chloroprene, phosphazenes, fluoroelastomers, perfluoroelastomers, and perfluoropolyether elastomers). In certain embodiments, any suitable type of elastomeric material that can be provided in liquid form and subsequently cured to form a solid can be used according to the invention. Accordingly, in some embodiments, a composite material comprising an elastomeric material and an electrospun material exhibiting the types of characteristics described herein with reference to composite materials comprising silicone and an electrospun polymeric material is provided according to the present disclosure.

Silicones are polymers having a Si—O—Si backbone, with varying pendant organic groups. Although not intended to be limiting, representative pendant organic groups include, but are not limited to, H, OH, alkyl groups (e.g., C1-C32 alkyl groups including methyl, ethyl, propyl, etc.), cycloalkyl groups, alkenyl groups, alkynyl groups, alkyl aryl groups (e.g., tolyl), aryl alkyl groups (e.g., benzyl and phenethyl); aryl alkenyl groups, aryl groups (e.g., phenyl groups), or hydrolyzable groups, any of which may be halogen-substituted. Typically, two pendant organic groups are present on each silicone atom of the polymer backbone and these groups can be the same or different. Any combination of pendant organic groups may be present on a silicone. Silicones can have varying 3-dimensional structures, including linear, ring, branched, cross-linked, and resin forms.

According to the present disclosure, certain silicones used herein are silicone elastomers. Preferably, silicones useful according to the present disclosure are polymers that can be provided in liquid form (i.e., as uncured polymers), which can subsequently be cured (e.g., through the application of heat and/or various types of reagents) to give a solid (cured) elastomeric material. Thus, silicone elastomers in their uncured form generally comprise some component that can be reacted to provide some degree of cross-linking between the polymer chains. Consequently, in their final (cured) form, silicones are generally partially or fully cross-linked, providing a 3-dimensional structure. The final physical properties of silicone elastomers are typically determined, at least in part, by the degree of cross-linking upon curing. In some embodiments, silicone elastomers can further comprise fillers (e.g., silica, quartz, diatoms, or metal oxides) in amounts typically from about 0% to about 40% by weight. Fillers can alter the mechanical and/or flow properties of the silicones and/or can be added to modify certain chemical or thermal properties.

Silicone elastomers are generally classified as room temperature vulcanizing (RTV) silicones, which can cure/cross-link at room temperature, high temperature vulcanizing (HTV) silicones (also known as silicone rubbers), which generally cure at temperatures above about 100° C., or liquid silicone rubbers (LSR/LR), which have low viscosity and paste-like behavior, cure at high temperatures, and are typically processed in injection molding machines. Particularly advantageous for use according to the methods described herein are HTV silicones, which can be provided in liquid form and cured by the later addition of heat. It is to be understood that selection of the silicone to be used can be dependent upon the end use of the composite material produced as provided herein.

Exemplary silicones include, but are not limited to, polydimethylsiloxane, decamethyltetrasiloxane, octamethyltrisiloxane, hexamethyldisiloxane, ethylbenzene vinyl polydimethylsiloxane, hexamethylcyclotrisiloxane, octamethylcyclotetrasiloxane, decamethylcyclopentasiloxane, and dodecamethylcyclohexasiloxane. Certain commercially available silicones include, but are not limited to, C6-135 elastomer, SILASTIC® silicones, and XIAMETER® silicones (Dow Corning); General Purpose Silicone (Specialty Silicone Products); COHRLASTIC® silicone rubber (Stockwell Elastomerics); BISCO® silicones (Rogers Corporation); ELASTOSIL® silicones (Wacker Chemie GmbH); RTV615, Siltrust silicones, (Momentive Performance Materials); and MED-6233 silicone elastomer (NuSil Silicone Technology). Generally, any silicone available in liquid uncured form can be used in the methods described herein.

### Electrospun Polymeric Component

The electrospun polymeric component of the composite materials provided herein is understood to comprise a polymeric mat prepared via an electrospinning process, which can be subsequently formed and/or treated as described herein. Electrospun mats typically comprise a plurality of fibers, which in some embodiments are in random orientation with respect to one another. In certain embodiments, electrospun mats can be described as fibrous and/or porous.

As used herein in reference to espun mats, “pore size” is intended to refer to effective pore size (rather than actual pore size) as measured, for example, by air flow and/or water flow (e.g., as defined by ASTM F316 Pore Size Characterization by Bubble Point, which is incorporated herein by this reference). It is noted that, given the nature of the espun fiber mats, it is generally not possible to measure actual pore size of such materials using microscopy methods. The effective pore size of a given espun component within a composite material of the present disclosure can range from about 0.0 μm (e.g., a non-porous film) to about 50 μm, e.g., from about 0.05 μm to about 20 μm. Advantageously, the effective pore size of the electrospun mat(s) used according to the methods of the present disclosure is greater than about 0.0 μm as, in certain embodiments, it is desired to provide a porous material to allow some degree of penetration of the silicone component into the electrospun polymeric material. The effective pore sizes of certain espun mats can be controlled to some extent by both electrospinning conditions used to prepare the electrospun component and by the treatment to which the components are subjected within the composite material.

In certain embodiments, the electrospun polymeric component of the composite materials described herein comprises a fibrous mat prepared via dispersion-based electrospinning (i.e., a dispersion-spun material). In certain embodiments, the fibrous mat prepared via dispersion-based electrospinning is an electrospun fibrous mat comprising a fluorinated polymer (e.g., poly(tetrafluoroethylene) (PTFE). Although the present description of electrospinning provided below focuses on electrospun mats comprising PTFE, it is noted that the methods and materials described herein may employ a different fluorinated polymer in place of the PTFE. Exemplary fluorinated polymers that can be incorporated as the electrospun polymeric material in the composite materials described herein include, but are not limited to, fluorinated ethylene propylene (FEP), polyvinylidene fluoride (PVDF), perfluoroalkoxy (PFA), a copolymer of tetrafluoroethylene, hexafluoropropylene and vinylidene fluoride (THV), poly(ethylene-co-tetrafluoroethylene) (ETFE), ethylene chlorotrifluoroethylene (ECTFE), PCTFE (polychlorotrifluoroethylene), and copolymers, blends, and derivatives thereof. Although the application as written is directed to embodiments wherein the fibrous mat prepared via dispersion-based electrospinning comprises a fluorinated polymer (e.g., PTFE), in some embodiments, the principles discussed in reference to the fluorinated polymer could be applied to other (non-fluorinated) types of polymers that could be spun from a dispersion under appropriate conditions to give suitable electrospun mats (e.g. and in theory, polyether ether ketone (PEEK)).

In some embodiments, the one or more electrospun polymeric materials comprise a solution-spun material. One exemplary solution-spun polymer that can be used in the composite materials disclosed herein is a polyurethane (PU). Other polymers include, but are not limited to, polydimethylsiloxane (PDMS), polyether block amide (PEBA), polyamides, polyethylene (e.g., ultra-high molecular weight polyethylene, UHMWPE), polyesters, and copolymers, blends, and derivatives thereof. Generally, any polymer that forms fibers upon electrospinning can be used in this regard as a solution-spun component of the composite materials described herein.

Electrospun mats generally can be prepared by drawing material by electrical charge from a polymeric solution, from a polymeric suspension/dispersion, or from a polymer melt. The fibers thus produced are typically collected in a random fashion to produce nonwoven materials. Various specific techniques are known for the production of electrospun fibers and electrospun materials (e.g., mats and/or coverings).

PTFE and other fluorinated polymers discussed herein are generally electrospun from dispersion (e.g., in one specific embodiment, an exemplary commercially available PTFE dispersion, Daikin D 210 PTFE, is used, which comprises about 59-61 wt % PTFE solids (measured according to ASTM D 4441), 6.0-7.2% wt % surfactant, a pH at 25° C. of 8.5 to 10.5, a specific gravity of 1.50 to 1.53 and a Brookfield viscosity maximum of 35 cP. A fiberizing polymer is typically added to the dispersion to facilitate fiber formation and is generally removed following the espinning process. The fiberizing polymer (or polymers) are typically selected such that they have a high solubility in the solvent of the dispersion (e.g., where the dispersion comprises water, any water-soluble polymer can be used, including, but not limited to, poly(ethyleneoxide)).

In preferable embodiments, the viscosity of the dispersion is within a certain desirable range to allow for the formation of uniform and consistent fibers therefrom (e.g., greater than about 50,000 cP, such as between about 50,000 cP and about 300,000 cP or between about 70,000 cP and about 150,000 cP, as measured with a Brookfield Viscometer using a #25 spindle and a spindle speed of 2.5 at 25° C. The desired viscosity of the dispersion may vary depending on whether a free surfaced-based apparatus or an orifice (needle)-based apparatus (which allows a somewhat higher viscosity) is used.

In one embodiment, free surface electrospinning from a wire, a cylinder in a trough (i.e., open bath, (free surface)), spike, sharp edge, or similar geometry spinning electrode or the like is used. For the open bath unit, the ejection volume is dependent upon the viscosity of the dispersion, the conductivity of the dispersion, the surface tension of the dispersion, the distance from bath to target, and the voltage. These factors can also affect the thickness of the fabric and the fiber diameter. The charge source is preferably connected to the positive side of a precision DC power supply. The negative side of the power supply is preferably connected to the collection surface. Alternatively, the collection surface can be at ground. The polarity can be reversed but this is not preferred. Voltage is applied (e.g., typically from about 40,000 volts to about 120,000 volts (e.g., about 40,000 to about 80,000 volts) over a typical collection distance of about 100 to about 400 mm) to uniformly draw out the dispersion and attract it to a collection surface.

In other embodiments, orifice or needle spinning is used. This method is similar to that described above; however, the polymeric dispersion passes through one, two, or several orifices and forms espun fibers and fabrics in this way. The voltage on the power supply is increased to the desired voltage (usually from about 2,000 to about 20,000 volts) to uniformly draw out the dispersion and attract it to the collection surface.

General information related to processes for processing and electrostatic spinning from dispersion (e.g., of PTFE from aqueous and other dispersions) is provided, for example, in U.S. Pat. No. 4,323,525 to Bornat and U.S. Pat. No. 4,044,404 to Martin et al., which are incorporated herein by reference in their entireties. In certain embodiments, electrospinning of PTFE may be based at least in part, on the process described in detail in U.S. Patent Appl. Publ. Nos. 2010/0193999 to Anneaux et al. and 2012/0114722 to Ballard et al., which are both incorporated herein by reference in their entireties. Various parameters of the nanofiber production process can be modified to alter the properties of the resulting dispersion-spun (e.g., PTFE) material. For example, increasing the length of time generally increase the thickness of the espun material.

Solution electrospinning is generally known in the art and, in some embodiments, can be conducted in a similar way as the dispersion-based electrospinning described above. Similar to dispersion-based electrospinning, an electrical charge is used to draw polymeric material from the solution and form fibers, which are deposited, generally in a random fashion, on a collection surface. Parameters such as makeup of the solution (e.g., the solvent, the composition and molecular weight of the polymer used, any additives, the concentration of the polymer in the solution, the solubility of the polymer in the solvent, etc.), the charge applied to the solution, the time period of electrospinning, etc. can impact the fibrous mat thus produced. Exemplary methods are described, for example, in U.S. Pat. Nos. 1,975,504; 2,160,962; and 2,187,306, all to Formhals; Demi et al., Polymer 43: 3303-3309 (2002); Greiner et al., Angew. Chem. Int. Ed. Engl. 46(30: 5670-5703 (2007), and Bhardwaj et al., Biotech. Adv. 28(3): 325-327, which are all incorporated herein by reference in their entireties. These and other methods for the preparation of electrospun mats from solution can be used according to the present disclosure. Electrospun materials produced via solution spinning generally do not require sintering to provide the desired fiber characteristics.

The solvent in which the polymer is dissolved for the purposes of solution-based electrospinning and the parameters required to produce fibrous mats via electrospinning of various polymers can vary. For example, where the polymer is PU, any solution in which the polymer is dissolvable (e.g., tetrahydrofuran (THF), dimethylformamide (DMF), dimethylacetamide (DMAc), and combinations thereof) may be appropriate. In some embodiments, it may be useful to use a combination of solvents such that one solvent evaporates more quickly than the other as the fibers are produced. The concentration of the polymer in the solution can vary, but is generally relatively low (e.g., less than about 25% by weight, less than about 10% by weight, such as between about 1% and about 10% by weight).

In both solution and dispersion-based electrospinning, the collection surface onto which the spun fibers are deposited can vary. In certain embodiments, the collection surface is a sheet, the surface of which can be any metal or polymeric material, with stainless steel being a particularly preferred material. In certain embodiments, the collection surface is a drum (i.e., a cylinder around which a collection sheet can be wrapped), which may be rotated during collection to generate a tubular structure. The tubular structure can be cut along the length of the tube to provide a sheet comprising the electrospun polymer. In certain embodiments, the collection surface is a rod or tube (i.e., a mandrel around which a collection sheet may be wrapped or on which the fibers may be collected directly) which may be rotated during the collection to generate a tubular structure. Such a tubular structure can, in certain embodiments, be directly used in its tubular form.

In certain embodiments, it is possible to tailor the properties of the composite materials described herein by modifying the properties of the electrospun mats (e.g., composition, thickness, effective pore size, fiber size, etc.). Tailoring as used herein refers to the ability to produce and use various materials with various properties. In some embodiments, tailoring relates to the process conditions used in espinning; by varying the parameters of the method, polymeric sheets or tubes having different physical properties can be obtained. For example, where a thicker polymeric mat is desired, the espinning process can be conducted for a longer period of time to deposit more material. As another example, where a polymeric mat with smaller pore size is desired, the targeted fiber diameter can be decreased. Further, selection of the chemical makeup of the espun mat or mats can provide an additional degree of tailoring.

In dispersion-based electrospinning, the polymeric (e.g., PTFE) mat/sheet or tube is generally somewhat fragile and typically must be heated and/or sintered to provide a sufficiently strong and durable material for use in any of the applications envisioned for the composite materials of the present disclosure. Heating generally serves to dry the material, volatilize and remove the fiberizing polymer, and/or to sinter the PTFE particles (e.g., by fusion of individual PTFE particles to produce a nonwoven, PTFE-based material). The sintering of the material generally results in the formation of a stronger, more durable material. The level of sintering can vary. During heating, the material can be monitored to evaluate the sintering level by various methods (e.g., by calorimetry and/or visual inspection). The material can be heated in place (i.e., by placing the entire collection surface in an oven) or by removing the electrospun material from the collection surface prior to heating and placing the free electrospun material in an oven.

The time and temperature at which the material is heated can vary. For example, in typical embodiments, the temperature of the oven is between about 250° C. and about 800° C., such as between about 300° C. and about 500° C. (e.g., between about 350° C. and about 485° C.). The samples are generally exposed for a period of time such that any remaining water is evaporated and the fiberizing polymer undergoes decomposition and subsequent elimination of the residual material. It is noted that the temperature at which a material is heated may depend, in part, on the makeup of that material.

The time for which a dispersion-espun material is heated may depend, in part, on the temperature of the oven. In some embodiments, the material is heated for a period of about an hour or less, about 30 minutes or less, about 20 minutes or less, about 15 minutes or less, or about 10 minutes or less. For example, in certain embodiments, the heating and/or sintering is conducted for a time of between about 2 and about 30 minutes, preferably between about 5 and about 20 minutes. It is noted that more time may be required for heating at lower temperature and less time may be required for heating at a higher temperature. The time required for drying and sintering can also depend on the thickness of the material, with thicker materials requiring more time to dry and/or sinter.

The drying, volatilizing, and sintering can occur simultaneously or in a series of steps. While not intended to be limited by any theory, it is believed that some drying (i.e., removal of the solvent) may occur upon completion of electrospinning. It is further believed that some small degree of fiber rearrangement may occur at this point. Then when the material is heated, preferably, the majority of the solvent and the fiberizing polymer (e.g., greater than about 80%, preferably greater than about 90% or 95%, and most preferably greater than about 98 or 99%) is removed from the PTFE material. It is understood that espun fabric generally undergoes shrinkage upon heating. While not limited to any theory, the shrinkage is believed to occur in two steps: the initial drying and fiber rearrangement following the electrospinning process, and the removal of solvent and fiberizing polymer by heating.

### Preparation of Composite Materials

Various methods can be used to prepare the composite materials described herein. In certain embodiments, an electrospun polymeric mat is prepared as described above and an elastomeric component (e.g., silicone) can be applied as a coating thereto. Where a dispersion-spun electrospun polymeric material is used, it is typically employed in sintered form as a fabric. The espun component is preferably fibrous and the diameter of the fibers within the espun component according to the present disclosure can vary as well. By varying the espun fiber diameter and mat thickness, in combination with the coating, heating and/or other techniques of this disclosure, it is possible to achieve the desired silicone content for specific burst strength, tensile and toughness properties.

Various average fiber diameters can be provided by fine tuning both the particle size and conductivity of a PTFE dispersion. In some embodiments, PTFE fiber diameters less than or equal to about 1500 nm, less than or equal to about 1000 nm, less than or equal to about 900 nm, less than or equal to about 800 nm, less than or equal to about 700 nm, less than or equal to about 600 nm, less than or equal to about 500 nm, less than or equal to about 400 nm, less than or equal to about 300 nm, less than or equal to about 200 nm, or less than or equal to about 100 nm can be obtained by providing an appropriate combination of dispersion PTFE particle size and dispersion conductivity. Thus, in some embodiments, the average diameter of the PTFE fibers is within the range of about 250 nm to about 1500 nm (e.g., about 463 nm to about 1500 nm, or between about 1500 nm and three times the average particle size of the PTFE in the espinning dispersion). In some embodiments, the average diameter of the PTFE fibers is between about 400 and about 900 nm. In certain embodiments, other espun materials (e.g., solution-spun materials) may comprise fibers having average diameters of at least about 0.01 μm.

In some embodiments, the espun component may have fibers deposited in a density such that there is a range of distances of about 0.1 μm to about 50 μm between points of contact. The thickness of the electrospun mats used according to the present disclosure can vary; in some embodiments, the electrospun component can have an average thickness ranging from about 0.0001 inches to about 0.25 inches.

The espun component may further include or otherwise be associated with one or more other features, such that the espun component may itself be a composite. As one example, one or more scrims or other features may be added to, mounted to, or otherwise associated with the electrospun material to add strength and/or other suitable characteristics. Accordingly and for example, the espun component may include an espun mat or fabric in combination with one or more other suitable features such as, but not limited to, scrim(s), or the like.

The uncured silicone component may be applied to the electrospun polymeric component, for example, as a liquid coating. For example, in one embodiment, an electrospun polymeric mat is prepared and sintered. Uncured silicone (e.g., in liquid form) is applied to one or more surfaces of the electrospun polymeric mat, typically in an amount sufficient to at least partially wet the mat. Advantageously, in certain embodiments, the silicone is applied only to one surface of the electrospun polymeric mat; consequently, the silicone may penetrate through the pores of the electrospun polymeric mat and reach the other surface of the electrospun polymeric mat. Accordingly, as used herein, “silicone-coated” refers to the fact that the silicone has been applied to one or more surfaces of the electrospun polymeric mat. In actuality, the silicone in some embodiments is not present as a structurally distinct “coating” on the electrospun polymeric mat, but rather may penetrate the pores of the electrospun polymeric mat to some extent.

The silicone can be applied in various ways to the electrospun polymeric mat. For example, in certain embodiments, it may be sprayed, painted, or dripped onto the surface of the mat or the mat may be dipped or otherwise brought into contact with the silicone liquid. Any suitable means of providing contact between the silicone and the electrospun polymeric mat can be employed.

In some embodiments, the silicone-coated electrospun mat can be directly cured, giving a cured, composite material in sheet form. Pressure can be applied, e.g., prior to curing in some embodiments, to promote penetration of (e.g., impregnation of) the silicone into the electrospun polymeric mat. Pressure may be applied, for example, by forcing the silicone-coated electrospun mat against a forming surface, such as, but not limited to, by closing the silicone-coated electrospun mat in a press. The resulting sheet may, in some embodiments, be substantially homogeneous throughout a cross-section of the sheet, or the sheet may exhibit any other of the suitable characteristics descried herein.

In some embodiments, it is desirable to form the silicone-coated electrospun polymeric mat into tubular form. In such embodiments, before forming the tube, the silicone-coated electrospun polymeric mat is optionally passed through an oven to partially cure the silicone. The partial curing can, in some embodiments, ensure that the silicone is retained within the pores of the electrospun polymeric mat during further processing. Pressure is typically applied to the partially cured silicone-coated, electrospun polymeric mat to enhance penetration of the silicone through the pores of the electrospun polymeric mat in certain embodiments. Generally, the pressure required to promote the penetration of silicone into the pores of the electrospun polymeric mat is relatively low.

At least partially reiterating from above, for carrying out or at least further facilitating the impregnating of the silicone into the electrospun mat, pressure may be applied, for example, by forcing the silicone-coated electrospun mat against a forming surface or compressing the silicone-coated electrospun mat between forming surfaces. In this regard, a forming surface may be annular, tubular, or the like, so that the forming surface may be in the form of a mandrel, or the like. In this regard and as schematically shown in FIG. 9, in some embodiments, the pressure is applied by wrapping or winding the silicone-coated electrospun polymeric mat 30 around or onto a suitable device, such as a mandrel 32. That is, FIG. 9 schematically illustrates a portion of a silicone-coated electrospun polymeric fabric or mat 30 being wound or wrapped around a mandrel 32, in accordance with one example of a suitable method of making composite materials. During the wrapping/winding, the silicone-coated electrospun polymeric mat 30 may be moved relative to the stationary mandrel 32 and/or the mandrel may be rotated relative the silicone-coated electrospun polymeric mat being supplied to the rotating mandrel. That is, the silicone-coated electrospun polymeric mat 30 may be wound onto the spindle by moving the polymeric mat 30 relative to the stationary mandrel 32 and/or rotating the mandrel relative the silicone-coated electrospun polymeric mat being supplied to the rotating mandrel.

Optionally, the silicone may already be partially cured at the time of the winding, as discussed above. As another option that is schematically shown in FIG. 9, the exterior surface of the mandrel 32 may be textured, as will be discussed in greater detail below. Whereas the silicone-coated electrospun polymeric mat 30 may be schematically shown as being wrapped perpendicularly to the longitudinal axis of the mandrel 32 in FIG. 9, there may optionally be an axial component to the winding, such that the silicone-coated electrospun polymeric mat is simultaneously wrapped around the mandrel and advanced along the length of the mandrel. Other variations are also within the scope of this disclosure.

The number of times the partially-cured silicone-coated electrospun polymeric mat is wrapped around the mandrel can vary and in some embodiments, varying the number of windings can vary the thickness of the composite material (e.g., the thickness of the wall of the tube) thus produced. For example, in some embodiments, the partially-cured silicone-coated electrospun polymeric mat is wrapped between about 1 and about 500 times, e.g., between about 2 and 200 times around the mandrel or between about 10 and about 100 times around the mandrel. Advantageously, it is wrapped at least about 10 times around the mandrel, at least about 20 times around the mandrel, at least about 30 times around the mandrel, at least about 40 times around the mandrel, at least about 50 times around the mandrel, at least about 60 times around the mandrel, at least about 70 times around the mandrel, at least about 80 times around the mandrel, at least about 90 times around the mandrel, or at least about 100 times around the mandrel. The pressure of physically wrapping the partially-cured silicone-coated electrospun polymeric mat around the tubular device may, in some embodiments, be sufficient to ensure substantial or complete penetration of the silicone into the pores of the electrospun polymeric component, providing an interpenetrating network of silicone in the pores of the electrospun polymeric component.

As alluded to above and as schematically shown in FIG. 9, in certain embodiments the exterior surface of the mandrel 32 is not smooth, but exhibits some type of patterning (e.g., a zig-zag structure with peaks and valleys, a wave-like structure, a grooved structure, etc.) on its exterior surface. For example, in FIG. 9, the exterior surface of the mandrel 32 is schematically illustrated as having a structured pattern including an alternating series of elongate ridges or protrusions, and elongate recesses or grooves, wherein each of the protrusions and grooves extends along the length of the tube. For example, the elongate grooves of the mandrel 32 may correspond in size and shape to, and form, the elongate protrusions 20 of the tubes of FIGS. 1, 7 and 8; and the elongate ridges or protrusions of the mandrel may correspond in size and shape to, and form, the elongate recesses or grooves 22 of the tubes of FIGS. 1, 7 and 8. That is, exemplary structures of the interior surfaces of tubes are shown in FIGS. 1, 7 and 8, and the exterior surface of the mandrel may define a “negative mold surface” for respectively forming the structured surfaces of FIGS. 1, 7 and 8. Similarly, the exterior surface of the mandrel may define a “negative mold surface” for forming any other suitable structured surfaces, or the like. Whereas exemplary structures are shown in FIGS. 1, 7 and 8, any other suitable type of structure patterning can be present. The intricacy of the features comprising the structured pattern can vary, the features can vary in size and can be raised or lowered with respect to the main or predominant outer surface of the mandrel. Alternatively, the exterior surface of the mandrel may be smooth/untextured.

In FIG. 9, the structure/texture at the exterior of the mandrel 32 is schematically shown. More specifically, the elongate protrusions or ridges of the mandrel 32 are schematically illustrated as lines extending along the outer surface of the mandrel. In certain embodiments, the mandrel 32 may have an outer diameter of about 0.2458 inches measured from the top of one ridge to the top of the opposite ridge farthest around the perimeter of the mandrel. The gap-like distance between the centerlines of adjacent ridges may be about 0.0059 inches. The height of each of the ridges may be about 0.0036 inches. More generally regarding the mandrel 32, the height of each of the ridges may be about 100 μm, or more or less, and the distance between the centerlines of adjacent ridges may be about 150 μm, or more or less. As another example regarding the mandrel 32, the height of each of the ridges may be about 150 μm, or more or less, and the distance between the centerlines of adjacent ridges may be about 200 μm, or more or less. As a further example regarding the mandrel 32, the height of each of the ridges may be about 200 μm, or more or less, and the distance between the centerlines of adjacent ridges may be about 250 μm, or more or less. Typically the height of each of the ridges of the mandrel 32 may be less than about 500 μm, or less than about 400 μm, and the distance between the centerlines of adjacent ridges may be less than about 750 μm, or less than about 600 μm. The above-provided dimensions regarding the ridges of the mandrel 32 are also applicable to the protrusions/ridges 20 of the tubes of FIGS. 1-8. Notwithstanding the foregoing, a wide variety of shapes and sizes are within the scope of this disclosure.

The mandrel may be constructed of metal, a sufficiently rigid polymeric material, or any other suitable material. In this regard and for example, the mandrel may be a tube at least partially formed by way of extrusion through a die, wherein the die forms the elongate grooves and protrusions of the mandrel tube. For example, the extruded mandrel tube may be constructed of high-temperature polyether ether ketone (PEEK), high-temperature fluoropolymers, or other suitable polymeric materials. Alternatively, the textured, structured external surface of the mandrel may be formed in any other suitable manner such as, but not limited to, etching.

At least partially reiterating from above for a method of making a composite in accordance with certain embodiments of this disclosure, as the partially-cured silicone-coated electrospun polymeric mat is pressed against the mandrel to form certain composite materials as described herein, a patterned mandrel having a given structure can, in some embodiments, endow the partially-cured silicone-coated electrospun polymeric mat with a textured/structured surface. For example, where the partially-cured silicone-coated electrospun polymeric mat is wrapped around a patterned mandrel, a tubular structure may be produced that exhibits a patterned inner surface, e.g., a structured surface (having the inverse pattern of the structure on the patterned mandrel).

In certain embodiments and at least in theory, a patterned/structured surface may be advantageous for various reasons. In some embodiments, the patterning on the interior of a tubular silicone-coated electrospun polymeric composite material may render that material easier to remove from the mandrel (e.g., when the composite material comprises silicone in partially cured and/or cured form). Additionally, in a formed tubing product produced from a silicone-coated electrospun polymeric composite, the tube exhibits a higher surface area on the interior due to the presence of a structure on the interior surface. The increased surface area may lead to numerous benefits, at least theoretically including the capability of that tubing to handle higher flow rates in use and/or including easing the amount of effort required for inserting tubes within one another.

The resulting wrapped silicone-coated electrospun polymeric mat can, in some embodiments, be directly cured, e.g., by passing the composite through an oven to heat the composite to a temperature sufficient to fully cure the silicone component. The wrapped composite material can be removed from the mandrel prior to curing or can be cured while still on the mandrel. Such a wrapped material can subsequently be removed from the mandrel to provide a fully cured tubing product. A composite material wrapped and cured around a mandrel can alternatively be cut along the longitudinal axis of the mandrel to provide the cured composite in sheet form. In some embodiments, the uncured composite can be processed into a desired shape prior to fully curing.

The preparation of composite devices according to the present disclosure is not limited to the method outlined above. In some embodiments, an electrospun polymeric mat and a silicone sheet can be separately prepared and combined, e.g., rolled in tandem or in succession around a mandrel to produce composite materials as described herein. In some embodiments, multiple mandrels and/or rollers can be used, and in some embodiments, other devices capable of applying pressure can be utilized according to the methods described herein.

According to the methods described herein, it is understood that various methods can be used for the application of pressure and varying pressures can be applied to provide varying levels of penetration of the liquid silicone elastomer into the pores of the electrospun polymeric mat. In some embodiments, the penetration of (e.g., impregnation of) the silicone into the electrospun polymeric component can be controlled by controlling the pressure applied to the composite and/or the amount of time for which pressure is applied over a given area. Where an excess of uncured silicone is added during the production of the composite materials described herein, it is noted that where complete penetration of the silicone into the pores of the electrospun polymeric mat is achieved, excess silicone may be present on one or both surfaces of the composite material. Depending upon the application, this excess silicone may be maintained, or may be removed to provide a more homogeneous cross-section.

In certain methods of production of composite materials as described herein, the presence of excess silicone on one or both surfaces of the silicone-coated electrospun polymeric mat can give rise to a composite material having a layered structure, comprising one or more layers of an interpenetrating network of espun polymeric material and silicone and one or more layers of silicone. For example, in a tube prepared as described above, by winding or wrapping a silicone-coated electrospun polymeric mat around a mandrel, numerous layers may be present in a cross-section of the tubing wall due to the presence of excess silicone.

The composite materials thus produced can be further processed (in uncured, partially cured, or cured form) in a variety of ways. For example, in some embodiments, articles can be fabricated by various molding techniques including, but not limited to, compression molding, injection molding, blow molding, extrusion, and lamination.

In accordance with at least one embodiment of this disclosure and at least partially reiterating from above, a method for producing a composite material may comprise at least partially impregnating silicone into an electrospun polymeric material, and at least further curing the silicone of the silicone-impregnated electrospun polymeric material. As should be apparent from the foregoing, the electrospun polymeric material may comprise poly(tetrafluoroethylene). In an example, regarding the impregnating, the electrospun polymeric material typically has pores therein, and the impregnating of the silicone into the electrospun polymeric material may comprise applying at least partially uncured silicone (e.g., in liquid form) to the electrospun polymeric material, and applying pressure to cause at least a portion of the silicone to penetrate at least a portion of the pores of the electrospun polymeric material. The applying of the pressure may comprise forcing the electrospun polymeric material to which silicone has been applied against a forming surface. The forming surface may be an outer surface of a mandrel, and the applying of the pressure may comprise wrapping the electrospun polymeric material to which silicone has been applied around the mandrel. The forming surface (e.g., of the mandrel) may define a structured pattern, and the forcing of the electrospun polymeric material to which silicone has been applied against the forming surface may comprise conforming at least a portion of the composite material to the structured pattern of the forming surface.

In accordance with at least one embodiment of this disclosure, a method of forming a tube may comprise wrapping an electrospun polymeric mat around a mandrel, with the mat being at least partially impregnated with silicone, and the mandrel defining a structured pattern. As should be apparent from the foregoing, the electrospun polymeric mat may be an electrospun poly(tetrafluoroethylene) fabric. The method may further comprise at least further curing the silicone of the mat, so that an inner surface of the tube defines a structured pattern substantially corresponding to the structured pattern of the mandrel. For example, the structured pattern of the mandrel may comprise recesses, and the method may comprise substantially segregating the silicone into the recesses, for example as at least generally discussed above at least with reference to the protrusions 20 shown in FIG. 1.

Other methods, steps and/or arrangements of steps are within the scope of this disclosure, additional examples of which are disclosed in the following.

### Exemplary Applications of Composite Materials

In certain embodiments, a range of products may comprise the composite materials described herein. Any of the types of products for which silicone and/or reinforced silicones are used may incorporate the types of composite materials described herein. Certain exemplary applications include, but are not limited to, tubing, gaskets, pump diaphragms, bellows, o-rings, and the like. Accordingly, each of FIGS. 1-8 and 10-12, or a portion thereof, may be characterized as being schematically illustrative of at least tubes, gaskets, pump diaphragms, bellows, o-rings, and the like. For example, each of the tubes, gaskets, pump diaphragms, bellows and o-rings of this disclosure may be conventional, except for the substitution thereinto of composite material(s) of this disclosure and/or other feature(s) of this disclosure.

In one embodiment, tubing comprising an electrospun polymeric component and a silicone component is provided. As described above, in certain embodiments there is preferably some degree of penetration of (e.g., impregnation of) the silicone component into the pores of the electrospun polymeric component, such that a cross-section of the tubular wall does not exhibit discrete layers, but rather is indicative of the merging of the silicone and electrospun polymeric “layers” to provide, e.g., a substantially homogeneous tubing wall cross-section. However, as described above, it is noted that in certain embodiments, discrete silicone layers may exist between such homogeneous (electrospun polymer/silicone interpenetrating network) layers, where the silicone coating applied to the electrospun component has filled the pores of the electrospun component and formed a coating on the top and/or bottom of the electrospun mat.

The wall thickness of the composite material-based tubing can vary, depending on the thickness of the partially-cured silicone-coated electrospun polymeric mat and on the number of wrappings of partially-cured silicone-coated electrospun polymeric mat around the mandrel, as described above. In preferred embodiments, the overall wall thickness of the composite material-based tubing is relatively uniform throughout the length of the tubing and around the circumference of the tubing.

Preferably, for tubing comprising the composite material described in the present disclosure, the degree of penetration of the silicone into the electrospun polymeric material is relatively high, such that the final material exhibits little to no porosity (to air and/or to water).

In other words, in some embodiments, the silicone advantageously penetrates a majority of the pores of the electrospun material, providing a material capable of preventing fluids from passing through the composite material (e.g., from the interior of the tubing to the exterior of the tubing). It is understood that, because the composite materials herein can be prepared in the form of numerous wrapped layers of silicone-coated electrospun polymeric material, a non-porous composite material may still be provided where silicone achieves less than 100% penetration into the pores of a given electrospun polymeric “layer.”

The tubing provided herein can be used for any of the purposes for which silicone tubing and/or reinforced silicone tubing is traditionally used. Representative tubing provided herein includes, but is not limited to, tubing for the biotechnology industry, pharmaceutical industry, food service industry, printing industry, brewing/fermentation industry, water purification industry, and the medical industry. It can also, for example, be used in electrical/mechanical insulation. In certain embodiments, tubing provided as described herein is advantageous for use as peristaltic tubing (i.e., tubing used in conjunction with a peristaltic pump). Accordingly, each of FIGS. 1-8 and 10-12, or a portion thereof, may be characterized as being schematically illustrative of peristaltic tubing. For example, the peristaltic tubing of this disclosure may be conventional, except for the substitution thereinto of composite material(s) of this disclosure and/or other feature(s) of this disclosure. Some specific applications for peristaltic pumps include, but are not limited to, pharmaceutical tablet coating, metering additives into various products, water filtration, and cell culture applications.

As described above, in certain embodiments, the tubing provided herein comprises a micron-structured inner diameter (ID) surface, giving a high surface area. In certain embodiments, it is advantageous to have such a structured ID in tubing, as it may allow the tubing to handle higher fluid flow rates therethrough.

In certain embodiments, the silicone is substantially evenly distributed along the entire ID surface, along the entire outer diameter (OD) surface, or along both the ID and OD surfaces along substantially the full length of the tubing. In some embodiments, the silicone is substantially evenly distributed throughout the entire thickness/cross-section of the tubing wall. Although not intended to be limiting, it is believed that the three-dimensional, tortuous structure and high permeability of the electrospun component allows for better penetration of silicone throughout the material. This enhanced penetration can, in some embodiments, lead to improved bonding strength between the silicone and electrospun materials and longer life of the resulting tube (or other material produced therefrom).

The final composite materials of the present disclosure can, in certain embodiments, be prepared with controlled fiber sizes and their mechanical properties can be tailored so as to improve such features as bond strength between the two or more components of the material, elongation properties, and tensile strength. Moreover, different pore sizes of electrospun mats can be targeted for different intended applications and to allow for varying degrees of silicone penetration therein. Advantageously, the composite materials described herein can exhibit significantly reduced silicone cracks due to the even distribution of the silicone in certain embodiments, e.g., as compared with other types of silicone composites.

In some embodiments, the composite materials provided herein can comprise one or more additives. It is understood that various additives can be added at any stage of the preparation process (i.e., during or after the electrospinning process, during or after the application of the silicone layer, and/or before or after curing of the silicone layer). Exemplary additives include fillers, pigments, dyes, thickeners/thinners, lubricants, accelerators, curing agents (e.g., cross-linking agents and condensation catalysts), adhesives and adhesion promoters, antioxidants, heat stabilizers, UV stabilizers, flame retardants, solvents, bioactive agents, processing aids, other modifiers known to those skilled in the art; and combinations thereof. Such additives can be included in varying amounts, e.g., about 0.01% to about 1% by weight of the final composite material.

Aspects of the present invention may be understood further in view of the following experimental examples, which are not intended to be limiting in any manner. All of the information provided herein represents both the values indicated and approximate values, unless otherwise specified.

### Example 1

In a first example, a 100% solids silicone compound (i.e., a silicone compound without solvent) was coated onto PTFE fabric and formed into a saturated PTFE fabric/silicone composite tube with indistinct layers, as shown in FIG. 10. For example, the composite tube of FIG. 10 may be characterized, as a whole, as being homogenous, as discussed above. The saturated composite tube had dimensions of ¼″ ID×⅜″ OD×17.75″ and required about 20 cc of the RTV615 Siltrust® silicone mixture and 30 wraps of 40μ thick espun PTFE fabric. This is equivalent to a roll length of approximately 62″ of the 40 g thick espun PTFE fabric.

The RTV615 Siltrust® silicone was applied evenly onto an 18 inch wide, 40 micron thick, espun PTFE fabric as it was being wound on a mandrel. Further regarding the applying of the silicone, the silicone was smoothly and evenly distributed only over about the first half of the fabric roll (determined as above). As the coated fabric was wound onto the mandrel the excess low viscosity silicone was forced through the espun layers (e.g., forced completely through at least some of the espun layers) to the surface of the roll. The fabric was wound until all the exuded silicone was absorbed by the fabric to obtain a homogeneous composite.

The uncured PTFE fabric/silicone composite tube and mandrel were then placed into a forming clam shell and heat was applied evenly to the entire assembly in an oven at a temperature of 150° C. for 30 to 120 minutes. After curing the assembly was removed from the oven and the clam shell and allowed to cool. After cooling the espun PTFE-silicone tube was removed from the mandrel and the OD determined at seven points along the tube. The resulting ODs for two exemplary tubes made according to the method disclosed above are as shown in Table 1.

TABLE 1
OD For a thirty wrap Espun PTFE - Silicone Composite
Tube Made with a Target OD of 0.375 inches.

| Location Along Tube Length | Tube 1 (in) | Tube 2 (in) |
|---|---|---|
| 2″ | 0.379 | 0.374 |
| 4″ | 0.375 | 0.375 |
| 6″ | 0.371 | 0.375 |
| 10″ | 0.369 | 0.372 |
| 12″ | 0.370 | 0.374 |
| 14″ | 0.378 | 0.375 |
| 16″ | 0.38 | 0.377 |
| Average OD | 0.374 | 0.375 |
| Std Dev | 0.005 | 0.001 |

In one aspect, the tube of FIG. 10 may be characterized as a product comprising a wall having opposite surfaces, wherein throughout a plane that extends through the wall and substantially perpendicular to the opposite surfaces (e.g., perpendicular to the lengthwise axis of the tube), the wall exhibits a substantially homogeneous cross-section.

As at least alluded to above and in accordance with at least one embodiment of this disclosure, the applying of the at least partially uncured silicone along the length of the electrospun polymeric material may comprise applying a predetermined amount of the at least partially uncured silicone along the length of the electrospun polymeric material, and varying the amount of the at least partially uncured silicone that is applied along the length of the electrospun polymeric material as a function of the length of the electrospun polymeric material. The varying of the amount of the at least partially uncured silicone that is applied along the length of the electrospun polymeric material may comprise applying a greater amount, per unit area, of the at least partially uncured silicone to a first portion of the electrospun polymeric material than to a second portion of the electrospun polymeric material. The wrapping of the length of the electrospun polymeric material around the mandrel may comprise wrapping the first portion of the electrospun polymeric material around the mandrel before wrapping the second portion of the electrospun polymeric material around the mandrel.

### Example 2

In a second example, a 100% solids silicone compound (i.e., a silicone compound without solvent) was coated onto PTFE fabric and formed into a saturated PTFE fabric/silicone composite tube with indistinct layers, as shown in FIG. 10. For example, the composite tube of FIG. 10 may be characterized, as a whole, as being homogenous, as discussed above. The saturated composite tube had dimensions of ¼″ ID× 7/16″ OD×18″ length and required about 30 cc of the RTV615 Siltrust® silicone mixture and 40 wraps of 40μ thick espun PTFE fabric. This is equivalent to a roll length of approximately 88″ of the 40μ thick espun PTFE fabric.

The RTV615 Siltrust® silicone was applied evenly onto an 18 inch wide, 40 micron thick, espun PTFE fabric as it was being rolled on a mandrel. Further regarding the applying, the silicone was smoothly and evenly distributed only over about the first half of the fabric roll (determined as above). As the coated fabric was wound onto the mandrel the excess low viscosity silicone was forced through the espun layers (e.g., forced completely through at least some of the espun layers) to the surface of the roll. The fabric was wound until all the exuded silicone was absorbed by the fabric to obtain a homogeneous composite.

The uncured PTFE fabric/silicone composite tube and mandrel were then placed into a forming clam shell and heat was applied evenly to the entire assembly in an oven at a temperature of 150° C. for 30 to 120 minutes. After curing the assembly was removed from the oven and the clam shell and allowed to cool. After cooling the espun PTFE-silicone tube was removed from the mandrel. The average burst pressures for three exemplary tubes made according to the method described above was determined and are as shown in Table 2.

TABLE 2
Burst Pressure for Espun PTFE - Silicone Composite Tubes (¼″
ID × 7/16″ OD × 18″ Length)

| Tube | Burst (Yes/No) | Pressure (psi) at Burst |
|---|---|---|
| 1 | Yes | 220 |
| 2 | Yes | 180 |
| 3 | Yes | 180 |
| Average | | 193 |
| Std Dev | | 23 |

To determine the burst pressure, nitrogen gas was used at room temperature to expand tubes clamped at one end up to bursting or a maximum pressure of 300 psi, whichever came first. As shown in Table 2, the average burst strength was 193 psi for the three tubes.

### Example 3

In a third example, a 100% solids silicone compound (i.e., a silicone compound without solvent) was coated onto PTFE fabric and formed into a gradient PTFE fabric/silicone composite tube with indistinct layers at the interior to fully distinct layers at the exterior, as shown in FIG. 11. The indistinct layers at the interior may be collectively referred to as a homogenous inner portion or layer of the tube, whereas the rest of the tube may be referred to as being in the form of alternating layers of the silicone and the silicone-impregnated electrospun polymeric material. More specifically and in one example, the alternating layers of the silicone and the silicone-impregnated electrospun polymeric material may more specifically be in the form of a single helical layer of silicone and a single helical layer of the silicone-impregnated electrospun polymeric material that together spiral outwardly in a concerted fashion. Irrespective, the outer portion of the wall of the tube may be characterized as having a cross-section that exhibits alternating layers of the silicone and the silicone-impregnated electrospun polymeric material. For example and as may be generally understood with reference to FIG. 11, a portion of the wall has a first layer comprising the silicone-impregnated electrospun polymeric material, a second layer contiguous with the first layer and consisting essentially of the silicone, a third layer contiguous with the second layer and comprising the silicone-impregnated electrospun polymeric material, a fourth layer contiguous with the third layer and consisting essentially of the silicone, and so on.

Similarly to Example 1, the RTV615 Siltrust® silicone was applied evenly onto a 10 inch wide, 40 micron thick, espun PTFE fabric as it was being wound on a mandrel. However, in Example 3 the silicone was added throughout the winding process. The silicone was smoothly and evenly distributed over the entire length of the fabric as it was being wound on the mandrel. As the coated fabric was wound onto the mandrel the excess low viscosity silicone was forced through the espun layers (e.g., forced completely through at least some of the espun layers) to the surface of the roll with the first layers having more pressure and time for the silicone to be exuded to the surface. Using this method, the interior of the tube has indistinct layers while the layers proximate the outer periphery are visible. The fabric was wound until the desired thickness was achieved.

The uncured PTFE fabric/silicone composite tube and mandrel were then placed into a forming clam shell and heat was applied evenly to the entire assembly in an oven at a temperature of 150° C. for 30 to 120 minutes. After curing the assembly was removed from the oven and the clam shell and allowed to cool. After cooling the espun PTFE-silicone tube was removed from the mandrel.

### Example 4

In a fourth example, a 100% solids silicone compound (i.e., a silicone compound without solvent) was coated onto PTFE fabric and formed into a PTFE fabric/silicone composite tube with distinct layers as shown in FIG. 12. As shown in FIG. 12, the tube may be referred to as being in the form of alternating layers of the silicone and the silicone-impregnated electrospun polymeric material. More specifically and in one example, the alternating layers of the silicone and the silicone-impregnated electrospun polymeric material may more specifically be in the form of a single helical layer of silicone and a single layer of the silicone-impregnated electrospun polymeric material that together spiral outwardly in a concerted fashion. Irrespective, the entire wall of the tube may be characterized as having a cross-section that exhibits alternating layers of the silicone and the silicone-impregnated electrospun polymeric material. Similarly to the above discussion with reference to FIG. 11, FIG. 12 illustrates that a portion of a tube wall has a first layer comprising the silicone-impregnated electrospun polymeric material, a second layer contiguous with the first layer and consisting essentially of the silicone, a third layer contiguous with the second layer and comprising the silicone-impregnated electrospun polymeric material, a fourth layer contiguous with the third layer and consisting essentially of the silicone, and so on.

Similarly to Example 3, the RTV615 Siltrust® silicone was applied evenly onto a 10 inch wide, 40 micron thick, espun PTFE fabric as it was being wound on a mandrel. The silicone was again smoothly and evenly distributed over the entire length of the fabric as it was being wound on the mandrel. However, in this technique the espun PTFE-silicone composite was at least partially cured by being heated as it was wound onto the mandrel. As the composite heats the silicone becomes more viscous and tacky and does not flow as readily to the espun PTFE as it was being wound on the mandrel. Thus, distinct layering of the composite was achieved. The fabric was wound until the desired thickness was achieved. In this example, the fabric was wound with enough pressure so that some of the silicone was at least partially impregnated into the espun PTFE, although variations are within the scope of this disclosure.

The uncured PTFE fabric/silicone composite tube and mandrel were then placed into a forming clam shell and heat was applied evenly to the entire assembly in an oven at a temperature of 150° C. for 30 to 120 minutes. After curing the assembly was removed from the oven and the clam shell and allowed to cool. After cooling the espun PTFE-silicone tube was removed from the mandrel.

In one aspect, the tubes of FIGS. 11 and 12 may be characterized as products comprising a wall with a cross-section that exhibits alternating layers of the silicone and the silicone-impregnated electrospun polymeric material.

### Example 5

In a fifth example a platinum (“Pt”) cured silicone was coated onto PTFE fabric and formed into a PTFE fabric/silicone composite tube with distinct layers generally as shown in FIG. 12 and discussed above. In this example, 15% solids solutions of a two part Pt catalyzed silicone elastomer, Dow-Corning C6-135A and C6-135B, were dissolved in mixed hexanes. Equal amounts of the prepared solutions were thoroughly mixed then cast on a sheet of foil. The silicone was smoothly and evenly distributed over the foil and the solvent in the silicone mixture was allowed to evaporate. The silicone sheet was then positioned onto a 10 wide, 40 micron thick espun PTFE fabric of similar length. Alternating layers of silicone and espun PTFE fabric were then wound around a mandrel and light pressure applied. Distinct layering of the composite was also achieved by this technique. The espun PTFE fabric and silicone layers were wound until the desired thickness was achieved. In this example, the fabric was wound with enough pressure so that some of the silicone was at least partially impregnated into the espun PTFE, although variations are within the scope of this disclosure.

The partially PTFE fabric/silicone composite tube and mandrel were then placed into a forming clam shell and heat was applied evenly to the entire assembly in an oven at a temperature of 150° C. for 10 minutes. After curing the assembly was removed from the oven and the clam shell and allowed to cool. After cooling the espun PTFE-silicone tube was removed from the mandrel.

As indicated above, the silicone may be at least partially cured, or substantially cured, before the silicone is applied to the electrospun polymeric material. Irrespective, the silicone is typically at least partially uncured when it is applied to the electrospun polymeric material, so that the silicone may be at least partially impregnated into the electrospun polymeric material.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A composite material comprising:
a porous electrospun polymeric material and silicone, wherein at least some of the silicone is impregnated in at least some of the porous electrospun polymeric material.

2. The composite material according to claim 1, wherein the electrospun polymeric material comprises poly(tetrafluoroethylene), and the at least some of the silicone penetrates at least a portion of at least some of the pores of the poly(tetrafluoroethylene).

3. The composite material according to claim 1, wherein the composite material comprises:
a first layer comprising the silicone-impregnated electrospun polymeric material; and
a second layer contiguous with the first layer, wherein the second layer consists essentially of the silicone.

4. The composite material according to claim 1, wherein the composite material has a surface defining a structured pattern.

5. A tube comprising the composite material according to claim 4, wherein the surface is an inner surface of the tube.

6. The composite material according to claim 4, wherein the structured pattern comprises a plurality of recesses.

7. The composite material according to claim 4, wherein the structured pattern comprises a plurality of protrusions.

8. The composite material according to claim 7, wherein at least some of the protrusions consist essentially of the silicone.

9. A product comprising the composite material of claim 1, wherein the product is annular.

10. A product comprising the composite material of claim 1, wherein the product is selected from the group consisting of a tube, a gasket, a pump diaphragm, a bellows and an o-ring.

11. A product defined by the composite material according to claim 1, wherein the product is a tube.

12. The product according to claim 11, wherein the tube is peristaltic pump tubing.

13. A product comprising the composite material of claim 1, wherein the product comprises a wall having opposite surfaces, and throughout a plane that extends through the wall and substantially perpendicular to the opposite surfaces, the wall exhibits a substantially homogeneous cross-section.

14. A product comprising the composite material of claim 1, wherein the product comprises a wall with a cross-section that exhibits alternating layers of the silicone and the silicone-impregnated electrospun polymeric material.

15. A method for producing a composite material, the method comprising:
at least partially impregnating silicone into an electrospun polymeric material; and
at least further curing the silicone of the silicone-impregnated electrospun polymeric material.

16. The method according to claim 15, wherein:
the at least partially impregnating of the silicone into the electrospun polymeric material comprises applying at least partially uncured silicone to the electrospun polymeric material; and
the method further comprises at least partially curing the silicone before the applying of the silicone to the electrospun polymeric material.

17. The method according to claim 15, wherein:
the at least partially impregnating of the silicone into the electrospun polymeric material comprises applying at least partially uncured silicone to the electrospun polymeric material, and winding the electrospun polymeric material; and
the method further comprises at least further curing the silicone that has been applied to a portion of the electrospun polymeric material prior to the winding of the portion of the electrospun polymeric.

18. The method according to claim 15, further comprising forcing at least some of the silicone to pass completely through at least some of the electrospun polymeric material.

19. The method according to claim 15, wherein the at least partially impregnating of the silicone into the electrospun polymeric material comprises applying at least partially uncured silicone along a length of the electrospun polymeric material, and winding the length of the electrospun polymeric material onto a mandrel.

20. The method according to claim 19, wherein the applying of the at least partially uncured silicone along the length of the electrospun polymeric material comprises applying a predetermined amount of the at least partially uncured silicone along the length of the electrospun polymeric material, and varying the amount of the at least partially uncured silicone that is applied along the length of the electrospun polymeric material as a function of the length of the electrospun polymeric material.

21. The method according to claim 20, wherein:
the varying of the amount of the at least partially uncured silicone that is applied along the length of the electrospun polymeric material comprises applying a greater amount, per unit area, of the at least partially uncured silicone to a first portion of the electrospun polymeric material than to a second portion of the electrospun polymeric material; and
the winding of the length of the electrospun polymeric material around the mandrel comprises winding the first portion of the electrospun polymeric material around the mandrel before winding the second portion of the electrospun polymeric material around the mandrel.

22. The method according to claim 15, wherein the electrospun polymeric material has pores therein, and the at least partially impregnating of the silicone into the electrospun polymeric material comprises:
applying at least partially uncured silicone to the electrospun polymeric material; and
applying pressure to cause at least a portion of the silicone to penetrate at least a portion of the pores of the electrospun polymeric material.

23. The method according to claim 22, wherein the electrospun polymeric material comprises poly(tetrafluoroethylene).

24. The method according to claim 22, wherein the applying of the pressure comprises forcing the electrospun polymeric material to which silicone has been applied against a forming surface.

25. The method according to claim 24, wherein the forming surface is an outer surface of a mandrel, and the applying of the pressure comprises winding the electrospun polymeric material to which silicone has been applied around the mandrel.

26. The method according to claim 24, wherein:
the forming surface defines a structured pattern; and
the forcing of the electrospun polymeric material to which silicone has been applied against the forming surface comprises conforming at least a portion of the composite material to the structured pattern of the forming surface.

27. A method of forming a tube, comprising:
winding electrospun polymeric fabric onto a mandrel, the fabric being at least partially impregnated with silicone, and the mandrel defining a structured pattern; and
at least further curing the silicone of the silicone-impregnated electrospun polymeric material, so that an inner surface of the tube defines a structured pattern substantially corresponding to the structured pattern of the mandrel.

28. The method according to claim 27, wherein the structured pattern of the mandrel comprises recesses, and the method comprises substantially segregating the silicone into the recesses.
